(19) United States
(12) Patent Application Publication
(10) Pub. No.: US 2024/0358035 A1
(43) Pub. Date: Oct. 31, 2024

(54) FLAVOR NANOEMULSIONS FOR BEVERAGE AND PERSONAL CARE APPLICATIONS

(71) Applicant: Firmenich SA, Satigny (CH)

(72) Inventors: Qiu-Min MA, Shanghai (CN); Wenhao LI, Shanghai (CN)

(73) Assignee: Firmenich SA, Satigny (CH)

(21) Appl. No.: 18/571,965

(22) PCT Filed: Jun. 1, 2022
(86) PCT No.: PCT/EP2022/064969

§ 371 Date: Dec. 19, 2023

(30) Foreign Application Priority Data
Jun. 28, 2021 (WO) PCT/CN2021/102609
Jul. 30, 2021 (EP) 21188644.5

(51) Int. Cl. A23D 7/01; A23L 2/56; A23L 27/00; A23L 27/12; C12G 3/06

(52) U.S. Cl. CPC A23D 7/011; A23L 2/56; A23L 27/13; A23L 27/80; C12G 3/06

(57) ABSTRACT

The present invention relates to a flavor nanoemulsion comprising a surfactant system comprising a polyoxyethylene sorbitan fatty acid ester and a polyglycerol ester of fatty acids (PGE), a non-polar phase comprising a flavor oil, and a polar phase. The invention further relates to a flavored beverage comprising the flavor nanoemulsion according to the invention.

### CROSS REFERENCE TO RELATED APPLICATIONS

The present application claims the benefit of priority of International Application No. PCT/CN2021/102609, filed Jun. 28, 2021, and of European Application No. 21188644.5, filed Jul. 30, 2021. The entire contents of these applications are explicitly incorporated herein by this reference.

### TECHNICAL FIELD

The present invention relates to a flavor nanoemulsion comprising a surfactant system comprising a polyoxyethylene sorbitan fatty acid ester and a polyglycerol ester of fatty acids (PGE), a non-polar phase comprising a flavor oil, and a polar phase. The invention further relates to a flavored beverage comprising the flavor nanoemulsion according to the invention.

### BACKGROUND OF THE INVENTION

For beverage applications, flavor compositions are desired. Flavor compositions are often in the form of emulsions comprising a polar phase, an oil phase, as well as a surfactant system. The aqueous phase typically comprises water and/or one or more polar co-solvents and further ingredients. The oil phase is typically dispersed within the aqueous phase thereby forming an oil-in-water emulsion. The dispersed oil phase typically comprises flavor oil(s) and optionally further lipophilic ingredients.

Such flavor emulsions have to fulfill a range of requirements. First of all, they should show a certain stability over a wide range of temperatures and storage conditions both in concentrated and in diluted form, i.e. within a beverage or personal care product. Moreover, the flavor composition should be clear in appearance after dilution, i.e. in a beverage.

Moreover, for universal applicability, flavor emulsions should also be stable in beverages showing acidic pH levels as well as in alcoholic beverages. However, many known flavor emulsions are hardly stable in acidic beverages and/or alcoholic beverages, as e.g. the surfactant system used may not be stable under acidic conditions or in the presence of ethanol.

In order to be useful for beverage applications, flavor emulsions also have to be able to carry sufficiently high amounts of flavor oil without showing any disadvantages as to the stability or appearance. A certain proportion of flavor oil in the flavor emulsion is needed in order to effectively provide flavor to a beverage.

Flavor emulsions can be in the form of a microemulsion or in the form of a nanoemulsion. Although less energy input is required to produce microemulsions and often higher oil loads are possible for microemulsions compared to nanoemulsions, a major disadvantage of flavor microemulsions is that microemulsions are typically very sensitive to composition changes, i.e. the formulation of the microemulsions often needs to be adapted for each individual type of flavor oil that is to be integrated in the flavor microemulsion. This is not only cumbersome, but also represents a big challenge for production at industrial scale.

Therefore, flavor emulsions would be desirable, wherein the flavor emulsion formulation is less dependent or even independent of the individual flavor oil used, which would be particularly useful for production at industrial scale. Moreover, in microemulsions often high amounts of water soluble and hydrophilic surfactants are required, which may result in foaming issues during beverage manufacturing making use of such microemulsions.

The present invention provides solutions for the above-mentioned advantages, and solutions to overcome the above-mentioned disadvantages associated with known flavor emulsions.

### DETAILED DESCRIPTION OF THE INVENTION

The present invention relates to a flavor nanoemulsion comprising
a surfactant system comprising
   a polyoxyethylene sorbitan fatty acid ester, and
   a polyglycerol ester of fatty acids (PGE),
a non-polar phase comprising a flavor oil, and
a polar phase.

An emulsion is a mixture of two liquids that are immiscible due to their different polarities (hydrophobic vs. hydrophilic). In an emulsion, one liquid (dispersed or internal phase) is dispersed in another liquid (external or continuous phase). Therefore, the non-polar phase may be dispersed within the polar-phase, or the polar phase may be dispersed within the non-polar phase.

In a particular embodiment, the non-polar phase is dispersed within the polar phase. In another particular embodiment, the polar phase is dispersed within the non-polar phase. Preferably, the non-polar phase is dispersed within the polar phase.

Double emulsions, such as water-in-oil-in-water (WOW) emulsions and its opposite, oil-in-water-in-oil (OWO) emulsions, with three distinct phases are known. With respect to the WOW type, the three distinct phases consist of polar phase droplets that are dispersed in a non-polar phase, which is then enclosed in a continuous polar phase. Such emulsions are not contemplated in the present disclosure. Therefore, the emulsions of the present disclosure are not double emulsions, i.e., the emulsions of the present disclosure are neither water-in-oil-in-water (WOW) emulsions nor oil-in-water-in-oil (OWO) emulsions. In an embodiment, the non-polar phase is dispersed within the polar phase and the non-polar phase is free of any polar phase. In another embodiment, the polar phase is dispersed within the non-polar phase and the polar phase is free of any non-polar phase. Typically, the non-polar phase is dispersed within the polar phase and the non-polar phase is free of any polar phase.

According to the invention, the emulsion is a nanoemulsion. In contrast to microemulsions, nanoemulsions are usually prepared by high-energy input, such as high-pressure homogenization to break the big droplets into small ones.

In a particular embodiment, the intensity weighted mean hydrodynamic diameter (Z-average value) of the oil droplets in the nanoemulsion is from 50 to 150 nm, preferably from 70 to 120 nm. Droplet sizes can be measured e.g. with a Zetasizer nano ZS (Malvern Instruments Limited, Worcs, UK).

The flavor nanoemulsion according to the present invention comprises a surfactant system comprising a polyoxyethylene sorbitan fatty acid ester and a polyglycerol ester of fatty acids (PGE).

In a particular embodiment, the surfactant system consists of a polyoxyethylene sorbitan fatty acid ester and a polyglycerol ester of fatty acids (PGE).

A surfactant system is required to obtain a nanoemulsion that is at least stable for a certain period of time. Surfactants (emulsifiers) show amphiphilic properties meaning that they contain both hydrophobic and hydrophilic moieties. Based on these structural properties, surfactants are surface-active, which allows them to reduce the interfacial tension between a polar and non-polar phase and thus, to stabilize an emulsion.

The composition according to the present invention comprises inter alia a polyoxyethylene sorbitan fatty acid ester as surfactant.

Polyoxyethylene sorbitan fatty acid esters are nonionic surfactants that are typically obtained by the reaction of ethylene oxide with sorbitan fatty acid esters.

In a particular embodiment, the polyoxyethylene sorbitan fatty acid ester is selected from the group consisting of polyoxyethylene(20)-sorbitan monolaurate, polyoxyethylene(20)-sorbitan monopalmitate, polyoxyethylene(20)-sorbitan monostearate, polyoxyethylene(20)-sorbitan monooleate, or any mixture thereof. Preferably the polyoxyethylene sorbitan fatty acid ester is polyoxyethylene(20)-sorbitan monooleate and/or polyoxyethylen(20)-sorbitan monostearate.

In a particular embodiment, the polyoxyethylene sorbitan fatty acid ester has an HLB (hydrophilic-lipophilic balance)-value of from 10 to 20, preferably of from 13 to 17.

In a particular embodiment, the nanoemulsion comprises the polyoxyethylene sorbitan fatty acid ester in an amount of from 0.5 to 20 wt. %, based on the total weight of the nanoemulsion, preferably from 2 to 10 wt. %, more preferably in an amount of from 4 to 9 wt. %.

According to the invention, the surfactant system further comprises a polyglycerol ester of fatty acids (PGE).

In a particular embodiment, the polyglycerol ester of fatty acids has a degree of polymerization of from 2 to 10 glycerol units. Preferably, the degree of polymerization is from 3 to 6.

In a particular embodiment, the fatty acids in the polyglycerol ester have a carbon number of from 12 to 18. Preferably, the carbon number is from 16 to 18, more preferably the carbon number is 18.

In a particular embodiment, the fatty acids in the polyglycerol ester are saturated fatty acids. Preferably, the saturated fatty acids are selected from the group consisting of lauric acid, myristic acid, palmitic acid, stearic acid, or any mixture thereof. More preferably, the fatty acid is stearic acid.

In a particular embodiment, the fatty acids in the polyglycerol ester are unsaturated fatty acids. Preferably, the unsaturated fatty acids are selected from the group consisting of oleic acid, linoleic acid, and linolenic acid. More preferably, the unsaturated fatty acid is oleic acid.

In a particular embodiment, the polyglycerol ester of fatty acids (PGE) is selected from the group consisting of triglyceryl monostearate, hexaglycerol penta-stearate, hexaglycerol tri-stearate, and tetraglycerol mono-oleate, or any mixture thereof.

In a particular embodiment, the polyglycerol ester of fatty acids (PGE) has an HLB-value of from 3 to 10, preferably from 4 to 8, more preferably the polyglycerol ester of fatty acids (PGE) has a HLB-value of from 4.5 to 7.5.

In a particular embodiment, the polyglycerol ester of fatty acids (PGE) has an HLB-value of less than 8.

In a particular embodiment, the nanoemulsion comprises the polyglycerol ester of fatty acids (PGE) in an amount of from 0.5 to 10 wt. %, based on the total weight of the nanoemulsion, preferably from 1 to 6 wt. %.

In a particular embodiment, the mass ratio of the polyoxyethylene sorbitan fatty acid ester to the polyglycerol ester of fatty acids (PGE) is from 20:1 to 1:20, preferably from 10:1 to 1:10.

The nanoemulsion according to the present invention further comprises a non-polar phase comprising a flavor oil.

Under “non-polar phase” is to be understood the total amount of hydrophobic compounds in the nanoemulsion according to the invention.

In a particular embodiment, the non-polar phase may further include one or more other active ingredients selected from oil-soluble pharmaceutical ingredients, oil-soluble nutraceutical ingredients (e.g., oil-soluble vitamins), oil-soluble colorants, oil-soluble antimicrobial ingredients, oil-soluble defoamers, mouthfeel modulators, taste modulators, and any combinations thereof. Useful taste modulators include acid maskers, beer hops, cooling agents, hot tasting substances, sweet enhancers, salt enhancers, salivation-inducing substances, substances causing a warmth or tingling feeling, and any combinations thereof. Exemplary mouthfeel modulators are coconut oil, coconut milk with or without sugar, vanillin, medium chain triglycerides, and combinations thereof. The cooling compound may be selected from the group consisting of: 2-(4-ethylphenoxy)-N-(IH-pyrazol-5-yl)-N-(2-thienylmethyl)acetamide, WS-23 (2-Isopropyl-N,2,3-trimethylbutyramide), FEMA 3804; WS-3 (N-Ethyl-p-menthane-3-carboxamide), FEMA 3455; WS-5 [Ethyl 3-(p-menthane-3-carboxamido)acetate], FEMA 4309; WS-12 (IR,2S,5R)-N-(4-Methoxyphenyl)-p-menthanecarboxamide, FEMA 4681; WS-27 (N-Ethyl-2,2-diisopropylbutanamide), FEMA 4557; N-Cyclopropyl-5-methyl-2-isopropylcyclohexanecarboxamide, FEMA 4693, WS-116 (N-(I,I-Dimethyl-2-hydroxyethyl)-2,2-diethylbutanamide), N-(I,I-Dimethyl-2-hydroxyethyl)2,2-diethylbutanamide, FEMA 4603, Menthoxyethanol, FEMA 4154, N-(4-cyanomethylphenyl)-p-menthanecarboxamide, FEMA 4496; N-(2-(Pyridin-2-yl)ethyl)-3-p-menthanecarboxamide, FEMA 4549; N-(2-Hydroxyethyl)-2-isopropyl-2,3-dimethylbutanamide, FEMA 4602 and (also N-(4-(carbamoylmethyl)phenyl)-menthylcarboxamide, FEMA 4684; (IR,2S,5R)-N-(4-Methoxyphenyl)-p-menthanecarboxamide (WS-12), FEMA 4681; (2S,5R)-N-[4-(2-Amino-2-oxoethyl)phenyl]-p-menthanecarboxamide, FEMA 4684; and N-Cyclopropyl-5-methyl-2-isopropylcyclohexanecarbonecarboxamide, FEMA 4693; 2-[(2-p-Menthoxy)ethoxy]ethanol, FEMA 4718; (2,6-Diethyl-5-isopropyl-2-methyltetrahydropyran, FEMA 4680);trans-4-tert-Butylcyclohexanol, FEMA 4724; 2-(p-tolyloxy)-N-(IH-pyrazol-5-yl)-N-((thiophen-2-yl)methyl)acetamide, FEMA 4809; Menthone glycerol ketal, FEMA 3807; Menthone glycerol ketal, FEMA 3748; (−)-Menthoxypropane-1,2-diol; 3-(I-Menthoxy)-2-methylpropane-1,2-diol, FEMA 3849; Isopulegol; (+)-cis & (−)-trans p-Menthane-3,8-diol, Ratio ˜ 62:38, FEMA 4053; 2,3-dihydroxy-p-menthane; 3,3,5-trimethylcyclohexanone glycerol ketal; menthyl pyrrolidone carboxylate; (IR,3R,4S)-3-menthyl-3,6-dioxaheptanoate; (IR,2S,5R)-3-menthyl methoxyacetate; (IR,2S,5R)-3-menthyl 3,6,9-trioxadecanoate; (IR,2S,5R)-3-menthyl 3,6,9-trioxadecanoate; (IR,2S,5R)-3-menthyl (2-hydroxyethoxy) acetate; (IR,2S,5R)-menthyl I I-hydroxy-3,6,9-trioxaundecanoate; Cubebol, FEMA 4497; N-(4-cyanomethylphenyl) p-menthanecarboxamide, FEMA 4496; 2-isopropyl-5-methylcyclohexyl 4-(dimethylamino)-4-oxobutanoate, FEMA 4230; N-(4-cyanomethylphenyl) p-menthanecarboxamide, FEMA 4496; N-(2-pyridin-2-ylethyl) p-;menthanecarboxamide, FEMA 4549, Menthyl lactate, FEMA 3748; 6-isopropyl-3,9-dimethyl-1,4-dioxaspiro[4.5]decan-2-one, FEMA 4285; N-benzo[I,3] dioxol-5-yl-3-p-menthanecarboxamide; N-(1-isopropyl-1,2-dimethylpropyl)-1,3-benzodioxole-5-carboxamide; N-(R)-2-oxotetrahydrofuran-3-yl-(IR,2S,5R)-p-menthane-3-carboxamide; mixture of 2,2,5,6,6-pentamethyl-2,3,6,6a-tetrahydropentalen-3a(IH)-ol and 5-(2-hydroxy-2-methylpropyl)-3,4,4-trimethylcyclopent-2-en-I-one; (IR,2S,5R)-2-isopropyl-5-methyl-N-(2-(pyridin-2-yl)ethyl)cyclohexanecarboxamide, FEMA 4549; (2S,5R)-2-isopropyl-5-methyl-N-(2-(pyridin-4-yl)ethyl)cyclohexanecarboxamide; N-(4-cyanomethylphenyl) p-menthanecarboxamide, FEMA 4496; (IS,2S,5R)-N-(4-(cyanomethyl)phenyl)-2-isopropyl-5-methylcyclohexanecarboxamide; I/7-isopropyl-4/5-methyl-bicyclo[2.2.2]oct-5-ene derivatives; 4-methoxy-N-phenyl-N-[2-(pyridin-2-yl)ethyl]benzamide; 4-methoxy-N-phenyl-N-[2-(pyridin-2-yl)ethyl]benzenesulfonamide; 4-chloro-N-phenyl-N-[2-(pyridin-2-yl)ethyl]benzenesulfonamide; 4-cyano-N-phenyl-N-[2-(pyridin-2-yl)ethyl]benzenesulfonamid; 4-((benzhydrylamino)methyl)-2-methoxyphenol; 4-((bis(4-methoxyphenyl)-methylamino)-methyl)-2-methoxyphenol; 4-((1,2-diphenylethylamino)methyl)-2-methoxyphenol; 4-((benzhydryloxy)methyl)-2-methoxyphenol, 4-((9H-fluoren-9-ylamino)methyl)-2-methoxyphenol; 4-((benzhydrylamino)methyl)-2-ethoxyphenol; I-(4-methoxyphenyl)-2-(I-methyl-1H-benzo[d]imidazol-2-yl)vinyl4-methoxybenzoate; 2-(1-isopropyl-6-methyl-1H-benzo[d]imidazol-2-yl)-I-(4-methoxyphenyl)vinyl4-methoxybenzoate; (Z)-2-(I-isopropyl-5-methyl-IH-benzo[d]imidazol-2-yl)-I-4-methoxy-phenyl)vinyl-4-methoxybenzoate; 3-alkyl-p-methan-3-ol derivatives; derivatives of fenchyl, D-bornyl, L-bornyl, exo-norbornyl, 2-methylisobornyl, 2-ethylfenchyl, 2-methylbornyl, cis-pinan-2-yl, verbanyl and isobornyl; menthyl oxamate derivatives; menthyl 3-oxocarboxylic acid esters; N-alpha-(Menthanecarbonyl)amino acid amides; p-menthane carboxamide and WS-23 analogs; (−)-(IR,2R,4S)-dihydroumbellulol; p-menthane alkyloxy amides; cyclohexane derivatives; butone derivatives; a mixture of 3-menthoxy-I-propanol and I-menthoxy-2-propanol; I-[2-hydroxyphenyl]-4-[2-nitrophenyl-]-1,2,3,6-tetrahydropyrimidine-2-one; 4-methyl-3-(I-pyrrolidinyl)-2[5H]-furanone; and combinations thereof.

In a particular embodiment, the non-polar phase is present in the nanoemulsion in an amount of from 0.5 to 30 wt. %, preferably from 17 to 25 wt. %, based on the total weight of the nanoemulsion.

In a particular embodiment, the non-polar phase consists of flavor oil.

In a particular embodiment, the nanoemulsion comprises the flavor oil in an amount of from 0.5 to 30 wt. %, based on the total weight of the nanoemulsion, preferably from 17 to 25 5 wt. %, more preferably the flavor oil is present in the nanoemulsion in an amount of 20 wt. %.

By “flavor oil”, it is meant here a flavouring ingredient or a mixture of flavouring ingredients, solvent or adjuvants of current use for the preparation of a flavouring formulation, i.e. a particular mixture of ingredients which is intended to be added to a composition to impart, improve or modify its organoleptic properties, in particular its flavour and/or taste. Taste modulator as also encompassed in said definition. Flavouring ingredients are well known to a skilled person in the art and their nature does not warrant a detailed description here, which in any case would not be exhaustive, the skilled flavourist being able to select them on the basis of his general knowledge and according to the intended use or application and the organoleptic effect it is desired to achieve. Many of these flavouring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, can Nostrand Co., Inc. Solvents and adjuvants or current use for the preparation of a flavouring formulation are also well known in the art.

In a particular embodiment, the flavor oil is selected from the group consisting of limonene, orange oil, lemon oil, grapefruit oil, lime oil, and any mixture thereof.

In a particular embodiment, the flavor oil comprises limonene. Preferably, the flavor oil consists of limonene.

In a particular embodiment, the flavor oil comprises orange oil. Preferably, the flavor oil consists of orange oil.

In a particular embodiment, the flavor oil comprises lemon oil. Preferably, the flavor oil consists of lemon oil.

In a particular embodiment, the flavor oil comprises grapefruit oil. Preferably, the flavor oil consists of grapefruit oil.

In a particular embodiment, the flavor oil comprises lime oil. Preferably, the flavor oil consists of lime oil.

In a particular embodiment, the flavor oil comprises lemon oil, grapefruit oil, and lime oil. 5 Preferably, the flavor oil consists of lemon oil, grapefruit oil, and lime oil.

The nanoemulsion according to the present invention further comprises a polar phase.

Under “polar phase” is to be understood the total amount of hydrophilic compounds in the nanoemulsion according to the invention.

In a particular embodiment, the polar phase is present in the nanoemulsion in an amount of from 50 to 80 wt. %, based on the total weight of the nanoemulsion. Preferably, the polar phase is present in the nanoemulsion in an amount of from 65 to 70 wt. %, based on the total weight of the nanoemulsion, more preferably in an amount of 68 wt. %.

In a particular embodiment, the polar phase comprises water. Preferably the amount of water in the polar phase is between 60 to 100 wt. %, based on the total weight of the polar phase.

In another particular embodiment, the amount of water in the polar phase is preferably higher than 80 wt. % based on the total weight of the polar phase. Preferably, the polar phase consists of water.

In a particular embodiment, the amount of water in the nanoemulsion is between 50 to 80 wt. %, based on the total weight of the nanoemulsion, preferably from 65 to 70 wt. %, more preferably the amount of water in the nanoemulsion is 68 wt. %.

In a particular embodiment, the polar phase comprises a polar non-aqueous solvent.

Under “polar non-aqueous solvent” is to be understood a polar (hydrophilic) solvent that is not water.

In a particular embodiment, the non-aqueous solvent is a food-grade solvent, in particular a non-aqueous solvent suitable for food compositions, in particular in combination with flavor ingredients.

In a particular embodiment, the polar phase comprises a non-aqueous solvent selected from the group consisting of glycerol, propylene glycol, benzylic alcohol, ethanol, propanol, isopropanol, 1,3-propanediol, butanol, butylene glycol, hexylene glycol, dipropylene glycol, ethoxydiglycol, triacetine, or any mixture thereof. Preferably, the polar non-aqueous solvent 5 is glycerol or propylene glycol, more preferably the polar non-aqueous solvent is propylene glycol.

In a particular embodiment, the polar phase comprises water and a non-aqueous solvent, selected from the group consisting of glycerol, propylene glycol, benzylic alcohol, ethanol, propanol, isopropanol, 1,3-propanediol, butanol, butylene glycol, hexylene glycol, dipropylene glycol, ethoxydiglycol, triacetine, or any mixture thereof. Preferably, the polar phase comprises water and propylene glycol.

In a particular embodiment, the polar phase consists of water and a non-aqueous solvent selected from the group consisting of glycerol, propylene glycol, benzylic alcohol, ethanol, propanol, isopropanol, 1,3-propanediol, butanol, butylene glycol, hexylene glycol, dipropylene glycol, ethoxydiglycol, triacetine, or any mixtures thereof. Preferably, the polar phase consists of water and propylene glycol.

In a particular embodiment, the polar non-aqueous solvent is present in the polar phase in an amount of from 5 to 80%, preferably from 20 to 60 wt. %, more preferably from 25 to 56 wt. %, based on the total weight of the polar phase.

In a particular embodiment, the polar non-aqueous solvent is present in the nanoemulsion in an amount of from 1 to 60%, preferably from 5 to 38 wt. %, more preferably from 10 to 25 wt. %, based on the total weight of the nanoemulsion.

In a particular embodiment, the polar phase comprises water and one or more polar non-aqueous solvent(s).

In a particular embodiment, the nanoemulsion is clear in appearance, i.e. a clear composition. Compositions having a NTU value of less than 10 are considered to have a clear appearance.

In a particular embodiment, the nanoemulsion according to the invention is obtained by blending the components of the nanoemulsion, pre-emulsifying the mixture using a high-speed-homogenizer, and homogenizing the mixture using a high-pressure homogenizer.

Preferably, the pre-emulsification step is carried out at from 1000 rpm to 25000 rpm, more preferably from 8000 rpm to 12000 rpm, yet more preferably at 10000 rpm. Preferably, the pre-emulsification step is carried out for 2 to 7 min, more preferably for 5 min.

Preferably, the high-pressure homogenization step is carried out at 450/50 bar using a 2-stage high-pressure homogenizer.

The present invention further relates to a method for preparing a nanoemulsion according to the invention, comprising the step of:
mixing a non-polar phase comprising a flavor oil and a polar phase in the presence of a surfactant system comprising a polyoxyethylene sorbitan fatty acid ester and a polyglycerol ester of fatty acids (PGE).

In a particular embodiment, the polyoxyethylene sorbitan fatty acid ester is added to the polar phase before the mixing of the polar phase with the non-polar phase is conducted. Preferably, the polar phase consists of water. Preferably, the polar phase is blended with the polyoxyethylene sorbitan fatty acid ester at a temperature of from 20 to 25° C. (room temperature) before being mixed with the non-polar phase.

In a particular embodiment, the polyglycerol ester of fatty acids is added to the non-polar phase before the mixing of the polar phase with the non-polar phase is conducted. Preferably, the non-polar phase consists of a flavor oil. Preferably, the non-polar phase is blended with the polyglycerol ester of fatty acids at a temperature of from 20 to 25° C. (room temperature) before being mixed with the polar phase.

In a particular embodiment, mixing of the non-polar phase and the polar phase is performed by using a high-speed homogenizer at between 1000 rpm and 25000 rpm, preferably from 8000 rpm and 12000 rpm, yet more preferably at 10000 rpm. Preferably, high-speed homogenization is performed for 1 to 10 minutes (min), preferably for 5 minutes (min). Preferably, an IKA, T25 Digital Ultra Turrax©, Germany, is used as high-speed homogenizer.

In a particular embodiment, high-speed homogenization as described above, is followed by a high-pressure homogenization step. Preferably, high-pressure homogenization is performed at 50/450 bar using a 2-stage high-pressure homogenizer. Preferably, high-pressure homogenization takes place 3 times in a row. Preferably, the high-pressure homogenizer used is a SPXFLOW, APV-1000 lab homogenizer, US.

The present invention further relates to a method for preparing a flavored beverage comprising the step of:
adding the nanoemulsion according to the invention to a beverage.

The present invention further relates to the use of a nanoemulsion according to the invention for the preparation of a flavored beverage.

The term “flavored beverage” includes flavored and cream sodas, powdered soft drinks, as well as liquid concentrates such as fountain syrups and cordials; coffee and coffee-based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

In case the nanomemulsion of the invention is used for the preparation of a flavored beverage, the compounds being comprised by the composition have to be selected such that they are suitable for human consumption. For example, the polar non-aqueous solvents mentioned above have to be selected such that they are suitable for human consumption. Therefore, butylene glycol and hexylene glycol should not be present in a nanemulsion according to the invention that is used for the preparation of a flavored beverage.

The nanoemulsion according to the present invention may also be used for the preparation of a personal care product.

Personal care products are typically applied to the human body for the purposes of cleaning, beautifying, promoting attractiveness or changing its appearance. Personal care products are for example, toothpaste or mouthwashes.

In a particular embodiment, the inventive nanoemulsion is used for the preparation of a mouthwash. Mouthwashes or mouth rinses are liquid oral care preparations developed to clean and refresh the oral cavity or oral surface by inhibiting or killing the microorganisms that cause malodor, dental caries, tooth decay, gum diseases, gingivitis, and periodontal disorders.

The present invention also relates to a flavored beverage comprising the nanoemulsion according to the invention.

In a particular embodiment, the flavored beverage comprises the nanoemulsion according to the invention in an amount of from 0.001 to 5 wt. %, based on the total weight of the flavored beverage, preferably of from 0.005 to 0.2 wt. %, more preferably of from 0.01 to 0.1 wt. %.

In a particular embodiment, the flavored beverage is an alcoholic or non-alcoholic beverage. Preferably the beverage is an alcoholic beverage. Preferably, the alcoholic beverage comprises ethanol in an amount of from 1 to 15 wt. %, more preferably of from 3 to 12 wt. %.

In a particular embodiment, the flavored beverage shows a turbidity (NTU) of less than 10. Preferably, the turbidity (NTU) is from 0.2 to 8, more preferably from 0.3 to 6.5.

The NTU-value refers to “Nephelometric Turbidity Units” that are representative for the turbidity of a composition, and are measured by means of a turbidimeter as specified by the United States Environmental Protection Agency. Preferably, turbidity is measured by a portable turbidity meter (Hanna instruments, Woonsocket, RI, HI93703). Generally, beverages or personal care products having a NTU value above 15 can be considered hazy and not clear. By contrast, beverages having a NTU of less than 10 are considered to have a clear appearance.

In a particular embodiment, the flavored beverage shows an acid pH-value. Preferably, the beverage shows a pH-value of from 2 to 6, more preferably from 2.5 to 4.0, yet more preferably the pH-value of the beverage is 2.8.

In a particular embodiment, the flavored beverage shows a pH-value of less than 4, preferably less than 3, more preferably the pH-value of the beverage is 2.8.

As the inventive nanoemulsion shows sufficient stability under acidic conditions, it can also be present in a beverage showing low pH-values.

In a particular embodiment, flavor oil is present in the beverage in an amount of between 0.001 to 0.5 wt. %, preferably from 0.005 to 0.02 wt. %, based on the total weight of the beverage.

In a particular embodiment, the polyoxyethylene sorbitan fatty acid ester is present in the beverage in an amount of from 0.001 to 0.5 wt. %, preferably from 0.002 to 0.01 wt. %, based on the total weight of the beverage.

In a particular embodiment, the polyglycerol ester of fatty acids (PGE) is present in the beverage in an amount of from 0.0005 to 0.5 wt. %, preferably from 0.0007 to 0.004 wt. %, based on the total weight of the beverage.

In a particular embodiment, water is present in the beverage in an amount of from 50 to 98 wt. %, based on the total weight of the beverage. In case of an acidic beverage, water is preferably present in the acidic beverage in an amount of from 85 to 95 wt. %, based on the total weight of the beverage. In case of an alcoholic beverage, water is preferably present in the alcoholic beverage in an amount of from 50 to 60 wt. %, based on the total weight of the beverage.

In a particular embodiment, sugar is present in the beverage in an amount of from 2 to 40 wt. %, based on the total weight of the beverage, preferably of from 6 and 27 wt. %.

In a particular embodiment, citric acid is present in the beverage in an amount of from 0.1 to 3 wt. %, based on the total weight of the beverage, preferably of from 0.3 to 1.5 wt. %.

In a particular embodiment, Vitamin C is present in the beverage in an amount of from 0.005 to 1 wt. %, based on the total weight of the beverage, preferably of from 0.005 to 0.01 wt. %.

In a particular embodiment, trisodium citrate dihydrate is present in the beverage in an amount of from 0.1 to 0.6 wt. %, based on the total weight of the beverage.

In a particular embodiment, sodium benzoate is present in the beverage in an amount of from 0.01 to 0.1 wt. %, based on the total weight of the beverage.

### EXAMPLES

### Example 1

### 1. Preparation of Flavor Nanoemulsions

Flavor nanoemulsions according to Samples 1 to 26 (Table 1) were prepared as follows: The polar phase was prepared by mixing polyoxyethylene(20)-sorbitan monooleate (Glycosperse® 0-20 K, Lonza) with water. The non-polar phase was prepared by blending limonene with different polyglycerol esters of fatty acids (PGE), at a temperature of between 20-25° C. The PGEs were triglycerol monostearate (Polyaldo® TGMS; Lonza Group Ltd.), hexaglycerol penta-stearate (SY-Glyster PS-5S; Sakamoto Yakuhin kogyo Co., Ltd.), hexaglycerol tri-stearate (SY-Glyster TS-5S; Sakamoto Yakuhin kogyo Co., Ltd.), and tetraglycerol mono-oleate (SY-Glyster MO-3S; Sakamoto Yakuhin kogyo Co., Ltd.), respectively.

Upon merging the non-polar phase with the polar phase, the mixture was pre-emulsified by using a high-speed homogenizer (IKA, T25 Digital Ultra Turrax®, Germany) at 10.000 rpm for 5 min. Afterwards, the obtained pre-emulsions were homogenized at 50/450 bar using a 2-stage high-pressure homogenizer (SPXFLOW, APV-1000 lab homogenizer, US). High-pressure treatment was repeated 3 times. Droplet sizes were measured by a Zetasizer nano ZS (Malvern Instruments Limited, Worcs, UK).

TABLE 1
Flavor nanoemulsion compositions

| | Sample | | | | | | | | | |
|---|---|---|---|---|---|---|---|---|---|---|
| | 1 | 2 | 3 | 4 | 5 | 6 | 7 | 8 | 9 | 10 |
| Ingredient | % wt | % wt | % wt | % wt | % wt | % wt | % wt | % wt | % wt | % wt |
| Limonene | 20 | 20 | 20 | 20 | 20 | 20 | 20 | 20 | 20 | 20 |
| triglycerol | 3 | — | — | — | 4 | — | — | — | — | — |
| monostearate | | | | | | | | | | |
| hexaglycerol | — | 3 | — | — | — | 4 | — | — | 3 | 3 |
| pentastearate | | | | | | | | | | |
| hexaglycerol | — | — | 3 | — | — | — | 4 | — | 1 | — |
| tristearate | | | | | | | | | | |
| tetraglycerol | — | — | — | 3 | — | — | — | 4 | — | 1 |
| monooleate | | | | | | | | | | |
| polyoxy- | 9 | 9 | 9 | 9 | 8 | 8 | 8 | 8 | 8 | 8 |
| ethylene(20)- | | | | | | | | | | |
| sorbitan | | | | | | | | | | |
| monooleate | | | | | | | | | | |
| Water | up | up | up | up | up | up | up | up | up | up |
| | to 100 | to 100 | to 100 | to 100 | to 100 | to 100 | to 100 | to 100 | to 100 | to 100 |
| Z-average* | 97.84 | 97.69 | 99.25 | 92.19 | 99.06 | 99.03 | 81.98 | 83.19 | 91.15 | 93.08 |
| (nm) | | | | | | | | | | |
| | Sample | | | | | | | | | |
| | 11 | 12 | 13 | 14 | 15 | 16 | 17 | 18 | 19 | 20 |
| Ingredient | % wt | % wt | % wt | % wt | % wt | % wt | % wt | % wt | % wt | % wt |
| Limonene | 20 | 20 | 20 | 20 | 20 | 20 | 20 | 20 | 20 | 20 |
| triglycerol | 5 | — | — | — | — | — | 6 | — | — | — |
| monostearate | | | | | | | | | | |
| hexaglycerol | — | 5 | — | — | 3 | 3 | — | 6 | — | — |
| pentastearate | | | | | | | | | | |
| hexaglycerol | — | — | 5 | — | 2 | 2 | — | — | 6 | — |
| tristearate | | | | | | | | | | |
| tetraglycerol | — | — | — | 5 | — | — | — | — | — | 6 |
| monooleate | | | | | | | | | | |
| polyoxy- | 7 | 7 | 7 | 7 | 7 | 7 | 6 | 6 | 6 | 6 |
| ethylene(20)- | | | | | | | | | | |
| sorbitan | | | | | | | | | | |
| monooleate | | | | | | | | | | |
| Water | up | up | up | up | up | up | up | up | up | up |
| | to 100 | to 100 | to 100 | to 100 | to 100 | to 100 | to 100 | to 100 | to 100 | to 100 |
| Z-average* | 89.57 | 82.33 | 70.38 | 82.49 | 86.12 | 90.22 | 99.84 | 94.11 | 89.44 | 87.52 |
| (nm) | | | | | | | | | | |

Sample

| | 21 | 22 | 23 | 24 | 25 | 26 |
|---|---|---|---|---|---|---|
| Ingredient | % wt | % wt | % wt | % wt | % wt | % wt |
| Limonene | 20 | 20 | 20 | 20 | 20 | 20 |
| triglycerol | 2.5 | 4 | 5 | 2 | 3 | 4 |
| monostearate | | | | | | |
| hexaglycerol | — | — | — | — | — | — |
| pentastearate | | | | | | |
| hexaglycerol | — | — | — | — | — | — |
| tristearate | | | | | | |
| tetraglycerol | — | — | — | — | — | — |
| monooleate | | | | | | |
| polyoxy- | 7.5 | 6 | 5 | 6 | 5 | 4 |
| ethylene(20)- | | | | | | |
| sorbitan | | | | | | |
| monooleate | | | | | | |
| Water | up | up | up | up | up | up |
| | to 100 | to 100 | to 100 | to 100 | to 100 | to 100 |
| Z-average* | 100.5 | 101.5 | 108.2 | 114.1 | 108.7 | 117.4 |
| (nm) | | | | | | |

*Z-average refers to the intensity weighted mean hydrodynamic diameter

### 2. Preparation of Beverages Using the Flavor Nanoemulsions According to Samples 1 to 26

Beverages A to Z were prepared by adding the flavor nanoemulsions (FNE) of Samples 1 to 26, respectively, to the beverage base according to Table 2 below. The beverages showed a pH-value of 2.8. The turbidity of the beverages was measured by a portable turbidity meter (Hanna instruments, H193703, US) and was reported in Nephelometric Turbidity Unit (NTU). The turbidity values of beverages A to Z are given in Table 3 below.

TABLE 2
Final acidic beverage compositions

| Ingredients | Mass (g) |
|---|---|
| FNE | 0.1 |
| Sugar | 60 |
| Citric acid anhydrous | 3.0 |
| Ascorbic Acid | 0.1 |
| Trisodium citrate dihydrate | 1.4 |
| Water up to | 1000 |

TABLE 3
Turbidity of the beverages

| Beverage | A | B | C | D | E | F | G | H | I | J | K | L | M |
|---|---|---|---|---|---|---|---|---|---|---|---|---|---|
| Turbidity | 0.68 | 2.41 | 2.75 | 0.97 | 2.35 | 0.85 | 1.08 | 1.24 | 1.33 | 1.78 | 2.83 | 0.71 | 0.37 |
| (NTU) | | | | | | | | | | | | | |
| Beverage | N | O | P | Q | R | S | T | U | V | W | X | Y | Z |
| Turbidity | 0.66 | 0.7 | 1.51 | 3 | 2.88 | 5.34 | 2.48 | 0.32 | 0.84 | 0.43 | 0.33 | 0.41 | 0.73 |
| (NTU) | | | | | | | | | | | | | |

As indicated by NTU values below 10, acidic Beverages A to Z were clear (translucent) in appearance.

### Example 2

### 1. Preparation of Flavor Nanoemulsions

Flavor nanoemulsions 27 to 29 were prepared as described in Example 1 under item 1. The only difference was that polyoxyethylen(20)-sorbitan monostearate was used instead of polyoxyethylene(20)-sorbitan monooleate. The compositions of flavor nanoemulsions 27 to 29 are given in Table 4 below.

TABLE 4
Flavor nanoemulsion compositions

| | Sample | | |
|---|---|---|---|
| | 27 | 28 | 29 |
| Ingredient | % wt | % wt | % wt |
| Limonene | 20 | 20 | 20 |
| hexaglycerol pentastearate | 3 | — | — |
| hexaglycerol tristearate | — | 3 | — |
| tetraglycerol monooleate | — | — | 3 |
| polyoxyethylen(20)- | 9 | 9 | 9 |
| sorbitan monostearate | | | |
| Water | up to 100 | up to 100 | up to 100 |
| Z-average* (nm) | 93.87 | 87.76 | 86.03 |

*Z-average refers to the intensity weighted mean hydrodynamic diameter

### 2. Preparation of Beverages Using the Flavor Nanoemulsions According to Samples 27 to 29

Beverages AA, AB, and AC were prepared by adding the flavor nanoemulsions (FNE) of Samples 27 to 29, respectively, to a beverage base according to Table 5 below. The beverages showed a pH-value of 2.8. The turbidity of the beverages was measured by a portable turbidity meter (Hanna instruments, H193703, US) and was reported in Nephelometric Turbidity Unit (NTU). The turbidity values of Beverages AA, AB, and AC are given in Table 6 below.

TABLE 5
Final acidic beverage compositions

| Ingredients | Mass (g) |
|---|---|
| FNE | 0.1 |
| Sugar | 60 |
| Citric acid anhydrous | 3.0 |
| Ascorbic Acid | 0.1 |
| Trisodium citrate dihydrate | 1.4 |
| Water up to | 1000 |

TABLE 6
Turbidity of the beverages

| Beverage | AA | AB | AC |
|---|---|---|---|
| Turbidity (NTU) | 0.52 | 0.74 | 0.82 |

As indicated by NTU values below 10, acidic Beverages AA, AB, and AC were clear (translucent) in appearance.

### Example 3 (comparative Example)

Flavor nanoemulsions C1 to C3 were prepared as described in Example 1 under item 1. However, in Example 3 polyoxyethylene(20)-sorbitan monooleate was used as the sole surfactant, i.e. no PGE was present in the nanoemulsion. The compositions of flavor nanoemulsions C1 to C3 are given in Table 7 below.

TABLE 7
Flavor nanoemulsion compositions

| | Sample | | |
|---|---|---|---|
| | C1 | C2 | C3 |
| Ingredient | % wt | % wt | % wt |
| Limonene | 20 | 20 | 20 |
| polyoxyethylene(20)- | 12 | 12 | 12 |
| sorbitan monooleate | | | |
| Water | up to 100 | up to 100 | up to 100 |

It was observed that phase separation immediately occurred upon production of the flavor nanoemulsions C1 to C3. Hence, nanoemulsions C1 to C3 were not stable.

### Example 4

### 1. Preparation of Flavor Nanoemulsions

Flavor nanoemulsions 30 to 34 comprising different kinds of flavor oils were prepared as described in Example 1 under item 1. The compositions of flavor nanoemulsions 30 to 34 are given in Table 8 below.

TABLE 8
Flavor nanoemulsion compositions.

| | Sample | | | |
|---|---|---|---|---|
| | 30 | 31 | 32 | 33 |
| Ingredient | % wt | % wt | % wt | % wt |
| Orange oil | 20 | | | |
| Lemon oil | — | 20 | — | — |
| Grapefruit oil | — | — | 20 | — |
| Lime oil | — | — | — | 20 |
| triglyceryl monostearate | 3 | 3 | 3 | 3 |
| polyoxyethylene(20)- | 9 | 9 | 9 | 9 |
| sorbitan monooleate | | | | |
| Water | up to 100 | up to 100 | up to 100 | up to 100 |
| Z-average* (nm) | 88.77 | 103.5 | 89.44 | 80.68 |

*Z-average refers to the intensity weighted mean hydrodynamic diameter

### 2. Preparation of Beverages Using the Flavor Nanoemulsions According to Samples 31 to 33

Beverages AD, AE, and AF were prepared by adding the flavor nanoemulsions of Samples 31 to 33 (FNE 31 to 33), respectively, to the beverage bases according to Table 9 below. The beverages showed a pH-value of 2.8. The turbidity of the beverages was measured by a portable turbidity meter (Hanna instruments, H193703, US) and was reported in Nephelometric Turbidity Unit (NTU).

TABLE 9
Final acidic beverage compositions.

| | AD | AE | AF |
|---|---|---|---|
| Ingredients | Mass (g) | Mass (g) | Mass (g) |
| FNE 31 | 0.25 | — | — |
| FNE 32 | — | 0.25 | — |
| FNE 33 | — | — | 0.25 |
| Sugar | 60 | 60 | 60 |
| Citric acid | 3.0 | 3.0 | 3.0 |
| anhydrous | | | |
| Ascorbic Acid | 0.1 | 0.1 | 0.1 |
| Trisodium citrate | 1.4 | 1.4 | 1.4 |
| dihydrate | | | |
| Water up to | 1000 | 1000 | 1000 |
| Turbidity (NTU) | 4.70 | 2.24 | 3.43 |

As indicated by NTU values below 10, acidic Beverages AD, AE, and AF were clear (translucent) in appearance.

Beverages AG, AH, and Al were prepared by adding the flavor nanoemulsions (FNE) of Samples 31 to 33, respectively, to an alcoholic beverage base according to Table 10 below. The turbidity values of the final alcoholic beverages are also given in Table 10 below.

TABLE 10
Final alcoholic beverage compositions.

| | AG | AH | AI |
|---|---|---|---|
| Ingredients | Mass (g) | Mass (g) | Mass (g) |
| FNE 31 | 1 | — | — |
| FNE 32 | — | 1 | — |
| FNE 33 | — | — | 1 |
| Sugar | 270 | 270 | 270 |
| Ethanol* | 156.25 | 156.25 | 156.25 |
| Citric acid | 15 | 15 | 15 |
| anhydrous | | | |
| Trisodium citrate | 5.5 | 5.5 | 5.5 |
| dihydrate | | | |
| Sodium benzoate | 0.37 | 0.37 | 0.37 |
| Water up to | 1000 | 1000 | 1000 |
| Turbidity (NTU) | 6.19 | 4.81 | 5.77 |

*The indicated amount of ethanol refers to mL (equal to about 123.3 g)

As indicated by NTU values below 10, also alcoholic Beverages AG, AH, and Al were clear (translucent) in appearance.

In view of the above, a universal flavor emulsion in the form of a nanoemulsion was obtained that could be conveniently added to an acidic and an alcoholic beverage, while no adaption of the formulation was required for the tested flavor oils (lemon oil, grapefruit oil, and lime oil). The results indicate that a universal formulation has been found that works independent of the individual flavour oil being comprised in the formulation.

### Example 5

Foamability and foam stability of beverages containing flavor nanoemulsions were measured using dynamic foam analyzer (DFA100, Kruss, Germany).

Beverages AJ to AM were prepared using flavor nanoemulsions (FNE) 11, 12, 13, and 15 (see Table 1), respectively. The composition of Beverages AJ to AM is given in Table 11 below.

TABLE 11
Final acidic beverage compositions.

| Ingredients | Mass (g) |
|---|---|
| FNE | 0.4 |
| Sugar | 60 |
| Citric acid anhydrous | 3.0 |
| Ascorbic Acid | 0.1 |
| Trisodium citrate dihydrate | 1.4 |
| Water up to | 1000 |

Foamability was measured using sparging method at room temperature. The airflow was set at 0.3/L and the sparging time was 15s. Maximum foam height and foam lasting time were recorded. A beverage base (pH 2.8) without flavor nanoemulsion was taken as control. The results concerning the foamability and foam stability of Beverages AJ to AM are given in Table 12 below.

TABLE 12
Foamability and foam stability of the beverages

| | AJ | AK | AL | AM | Control |
|---|---|---|---|---|---|
| Foam height (mm) | 61 | 67.8 | 62 | 68.8 | 66 |
| Foam stability (s) | 0 | 0 | 0 | 0 | 0 |

As shown in Table 12, the foamability and foam stability of the beverages containing flavor nanoemulsions were similar to that of the beverage base without flavor (control). Therefore, the addition of flavor nanoemulsions at tested concentrations did not introduce foaming problem to the beverages.

### Example 6

The polar phase is prepared by mixing polyoxyethylene(20)-sorbitan monooleate (Glycosperse® 0-20 K, Lonza) with water and propylene glycol (sample 34) or glycerol (sample 35) as non-aqueous solvent. The non-polar phase is prepared by blending limonene with triglycerol monostearate (Polyaldo® TGMS; Lonza Group Ltd.) at a temperature of between 20-25° C. Upon merging the non-polar phase with the polar phase, the mixture is pre-emulsified by using a high-speed homogenizer (IKA, T25 Digital Ultra Turrax®, Germany) at 10.000 rpm for 5 min. Afterwards, the obtained pre-emulsions are homogenized at 50/450 bar using a 2-stage high-pressure homogenizer (SPXFLOW, APV-1000 lab homogenizer, US). High-pressure treatment is repeated 3 times. The compositions of flavor nanoemulsions 34 and 35 are given in Table 13 below.

TABLE 13
Flavor nanoemulsion compositions

| | Sample | | | | |
|---|---|---|---|---|---|
| | 34 | 35 | 36 | 37 | 38 |
| Ingredient | % wt | % wt | % wt | % wt | % wt |
| Limonene | 20 | 20 | — | — | — |
| Lemon oil | — | — | 20 | 20 | 20 |
| triglycerol | 4 | 4 | — | — | — |
| monostearate | | | | | |
| hexaglycerol | — | — | 5 | 5 | 5 |
| tristearate | | | | | |
| polyoxy- | 6 | 6 | — | — | — |
| ethylene(20)- | | | | | |
| sorbitan | | | | | |
| monooleate | | | | | |
| polyoxy- | — | — | 7 | 7 | 7 |
| ethylene(20)- | | | | | |
| sorbitan | | | | | |
| monostearate | | | | | |
| Propylene | 5 | — | — | — | — |
| glycol | | | | | |
| Glycerol | — | 5 | 30 | 35 | 40 |
| Water | up to 100 | up to 100 | up to 100 | up to 100 | up to 100 |

### Example 7

Storage stability of the flavor nanoemulsions were tested at an accelerated condition and the droplet size was measured using ZetaSizer Nano ZS (Malvern Instruments Ltd., UK). The results of selective flavor nanoemulsions were shown in Table 14.

| Sample | 31 | 32 | 33 | 34 |
|---|---|---|---|---|
| *Z-average (nm) after stored at | 90.65 | 86.35 | 92.36 | 95.60 |
| 40° C. for 4 months | | | | |

*Z-average refers to the intensity weighted mean hydrodynamic diameter

As shown in Table 14, the flavor nanoemulsions were very stable during storage.

1. A flavor nanoemulsion comprising
a surfactant system comprising
a polyoxyethylene sorbitan fatty acid ester, and
a polyglycerol ester of fatty acids (PGE),
a non-polar phase comprising a flavor oil, and
a polar phase.

2. The flavor nanoemulsion of claim 1, wherein the surfactant system consists of a polyoxyethylene sorbitan fatty acid ester and a polyglycerol ester of fatty acids (PGE).

3. The flavor nanoemulsion of claim 1, wherein the intensity weighted mean hydrodynamic diameter (Z-average value) of the oil droplets in the nanoemulsion is from 50 to 150 nm.

4. The flavor nanoemulsion according to claim 1, wherein the mass ratio of the polyoxyethylene sorbitan fatty acid ester to the polyglycerol ester of fatty acids (PGE) is from 20:1 to 1:20.

5. The flavor nanoemulsion according to claim 1, wherein the nanoemulsion comprises the polyoxyethylene sorbitan fatty acid ester in an amount of from 0.5 to 20 wt. %, based on the total weight of the nanoemulsion.

6. The flavor nanoemulsion according to claim 1, wherein the nanoemulsion comprises the polyglycerol ester of fatty acids (PGE) in an amount of from 0.5 to 10 wt. %, based on the total weight of the nanoemulsion.

7. The flavor nanoemulsion according to claim 1, wherein the nanoemulsion comprises the flavor oil in an amount of from 0.5 to 30 wt. %, based on the total weight of the nanoemulsion.

8. The flavor nanoemulsion according to claim 1, wherein the polyglycerol ester of fatty acids (PGE) has an HLB-value of less than 8.

9. The flavor nanoemulsion according to claim 1, wherein the polar phase comprises water and/or one or more polar non-aqueous solvents.

10. The flavor nanoemulsion according to claim 1, wherein the nanoemulsion comprises water in an amount of from 50 to 80 wt. %, based on the total weight of the nanoemulsion.

11. The flavor nanoemulsion according to claim 1, wherein the polyoxyethylene sorbitan fatty acid ester is selected from the group consisting of polyoxyethylene(20)-sorbitan monolaurate, polyoxyethylene(20)-sorbitan monopalmitate, polyoxyethylene(20)-sorbitan monostearate, polyoxyethylene(20)-sorbitan monooleate, or any mixture thereof.

12. The flavor nanoemulsion according to claim 1, wherein the polyglycerol ester of fatty acids has a degree of polymerization of from 2 to 10 glycerol units and/or the fatty acids in the polyglycerol ester have a carbon number of from 12 to 18.

13. A flavored beverage comprising the flavor nanoemulsion according to claim 1.

14. The flavored beverage of claim 13, wherein the beverage is an acidic beverage and/or an alcoholic beverage.

15. The flavored beverage of claim 14, wherein the beverage has a pH value of less than 4.

16. The flavor nanoemulsion of claim 3, wherein the intensity weighted mean hydrodynamic diameter (Z-average value) of the oil droplets in the nanoemulsion is from 70 to 120 nm.

17. The flavor nanoemulsion according to claim 4, wherein the mass ratio of the polyoxyethylene sorbitan fatty acid ester to the polyglycerol ester of fatty acids (PGE) is from 10:1 to 1:10.

18. The flavor nanoemulsion according to claim 7, wherein the nanoemulsion comprises the flavor oil in an amount of from 17 to 25 wt. %, based on the total weight of the nanoemulsion.

19. The flavor nanoemulsion according to claim 11, wherein the polyoxyethylene sorbitan fatty acid ester is polyoxyethylene(20)-sorbitan monooleate and/or polyoxyethylene(20)-sorbitan monostearate.

20. The flavored beverage of claim 15, wherein the beverage has a pH value of less than 3.
